(19) United States
(12) Patent Application Publication
(10) Pub. No.: US 2015/0129639 A1
(43) Pub. Date: May 14, 2015

(54) SYSTEMS AND METHODS FOR KEYED WELDING CLAMP

(71) Applicant: Lincoln Global, Inc., City of Industry, CA (US)

(72) Inventor: VICTOR MILLER, Jamul, CA (US)

(73) Assignee: LINCOLN GLOBAL, INC., CITY OF INDUSTRY, CA (US)

(21) Appl. No.: 14/177,729

(22) Filed: Feb. 11, 2014

Related U.S. Application Data
(60) Provisional application No. 61/903,262, filed on Nov. 12, 2013.

(51) Int. Cl. B23K 37/02; F16B 2/12

(52) U.S. Cl. CPC B23K 37/0241; B23K 37/027; F16B 2/12
USPC 228/29; 248/674; 29/428

(57) ABSTRACT

The invention described herein generally pertains to systems and methods for accurately and precisely mounting an orbital welder for static use. Clamp systems as described herein can include a keyed welding clamp assembly for retaining the orbital welder having an orbital welder clamp, a clamp adapter, and a clamp mount. Similarly, methods herein can include disposing a welder extension in a first extension recess of a first clamp portion and a second extension recess of a second clamp portion, aligning an alignment key with a first key recess of the first clamp portion and a second key recess of the second clamp portion, and closing the first clamp portion toward the second clamp portion using a clamp mechanism. An operational welding system including clamps herein can further include the orbital welder and/or components thereof.

### CROSS-REFERENCE TO RELATED APPLICATIONS AND INCORPORATION BY REFERENCE

This U.S. patent application is a continuation of and claims the benefit of U.S. provisional patent application 61/903,262 filed on Nov. 11, 2013, which is incorporated herein by reference in its entirety.

### TECHNICAL FIELD

In general, the present invention relates to arranging an orbital welder for static use. More particularly, the present invention relates to accurately and repeatably securing an orbital welder to a structure to permit maneuvering of a work piece about the orbital welder.

### BACKGROUND OF THE INVENTION

In industrial applications, welding may involve raising, cladding, building up, filling, hard facing, overlaying, joining, and other welding applications. When confronted with a work piece having a curved surface, an orbital welding process may be used to rotate the welding head to apply a weld to the curved surface. The most common examples where orbital welding is used is the welding of pipe. Pipe welding may include thin walled application where the welding head is rotated about the outer surface where two piece ends of pipe are joined together. Alternatively, pipe welding may include deep groove geometries where the welding electrode extends into a groove formed between the two pipes being joined to lay down successive beads of weld material to fill the groove to join the thick walled pipes. Orbital welding systems may include a welding head that is mounted on a guide track or a fixture that clamps or is otherwise supported on the work piece and rotated to supply a weld.

In some specific instances, the work piece size, geometry, or other configurations make it difficult to mount an orbital welding track on the work piece. For example, hydraulic tubing is sometimes specified to conform to geometries about which it is difficult to maneuver a welder. Such work piece arrangements can also be onerous to weld by hand using orbital or other welders.

### SUMMARY OF THE INVENTION

In accordance with an embodiment of the present invention, a clamp for an orbital welder can comprise an orbital welder clamp having a first clamp portion and a second clamp portion, where the first clamp portion of the orbital welder clamp having a first key recess and a first extension recess, and where the second clamp portion of the orbital welder clamping having a second key recess and a second extension recess. The second key recess and the first key recess mate with the alignment key of the orbital welder where the first clamp portion is around the extension in a closed position with respect to the second clamp portion. There is also included a clamp adapter having at least two flanges and an interface plate, where the at least two flanges couple with the second clamp portion, and where the interface plate of the clamp adapter configured to operatively couple the orbital welder clamp and the clamp mount. The clamp also comprises at least one structure attachment mechanism of the clamp mount that attaches to an external structure.

In accordance with another embodiment of the present invention, a method of fixing an orbital welder includes disposing a welder extension in a first extension recess of a first clamp portion and a second extension recess of a second clamp portion, aligning an alignment key with a first key recess of the first clamp portion and a second key recess of the second clamp portion and closing the first clamp portion toward the second clamp portion using a clamp mechanism.

In still another embodiment, a welder system includes an orbital welder having a main body assembly supported adjacent to a workpiece, an extension of the orbital welder, and an alignment key of the orbital welder. This is used in conjunction with a keyed welding clamp assembly for retaining the orbital welder having an orbital welder clamp, a clamp adapter, and a clamp mount. The keyed welding clamp assembling includes a first clamp portion of the orbital welder clamp having a first key recess and a first extension recess and a second clamp portion of the orbital welder clamping having a second key recess and a second extension recess. The second key recess and the first key recess mate with the alignment key of the orbital welder where the first clamp portion is around the extension in a closed position with respect to the second clamp portion. The keyed welding clamp also includes at least one flange of the clamp adapter that couples with the second clamp portion, and an interface plate of the clamp adapter configured to operatively couple the orbital welder clamp and the clamp mount. In addition, the keyed welding clamp includes a closure mechanism of the clamp mount that pinches the external structure between a closure contact and a static face of the clamp mount, and a mounting aperture through the static face of the clamp mount.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a perspective view of a keyed welding clamp assembly;

FIG. 2 illustrates another perspective view of a keyed welding clamp assembly;

FIGS. 3 illustrates a side view of a keyed welding clamp assembly;

FIGS. 4A and 4B illustrate top and bottom views of a keyed welding clamp assembly;

FIGS. 5A and 5B illustrate rear and front views of a keyed welding clamp assembly; and

FIG. 6 illustrates an exploded view of a keyed welding clamp assembly; and

FIGS. 7A and 7B illustrate an orbital welder for use in conjunction with a keyed welding clamp assembly.

### DETAILED DESCRIPTION OF THE INVENTION

The innovation disclosed generally pertains to a mount or clamp which positively secures an orbital welder to a table, stand, or other structure such that a work piece can be precisely maneuvered through or about the welder. To ensure a secure, stable fit and accurate alignment of the welder, the clamp is configured to specifically retain a matched portion of the welder, and includes a key pattern permitting a key of the welder to mate with a key recess of the clamp. The work piece can be used in conjunction with a fixture and/or jig, or other components for alignment and retention, to properly feed the work piece to or through the clamped orbital welder.

As used herein, a key pattern is a nonlinear, two- or three-dimensional pattern that provides positive locking between a key (and components attached thereto) and a key recess (and components attached thereto). In the illustrated embodiments, a faceplate connecting an extension (e.g., handle, motor case, other extremity of an orbital welder) to an orbital welder includes a key configured to mate with a key recess of a clamp. Using this mating connection, the clamp can accurately and securely retain the orbital welder for stationary use. Other embodiments and configurations will be apparent to those of ordinary skill in the art upon review of the disclosures herewith.

“Welding” or “weld” as used herein including any other formatives of these words will refer to depositing of molten material through the operation of an electric arc including but not limited to submerged arc, GMAW, MAG, MIG, TIG welding, or any electric arc used with a welding system, an orbital welding system, or non-orbital welding system.

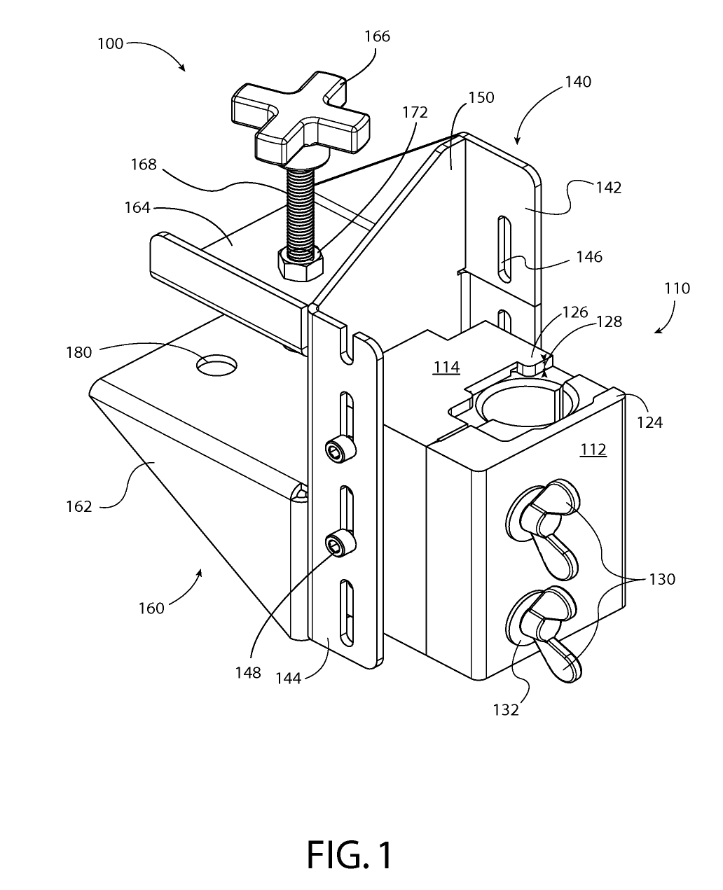

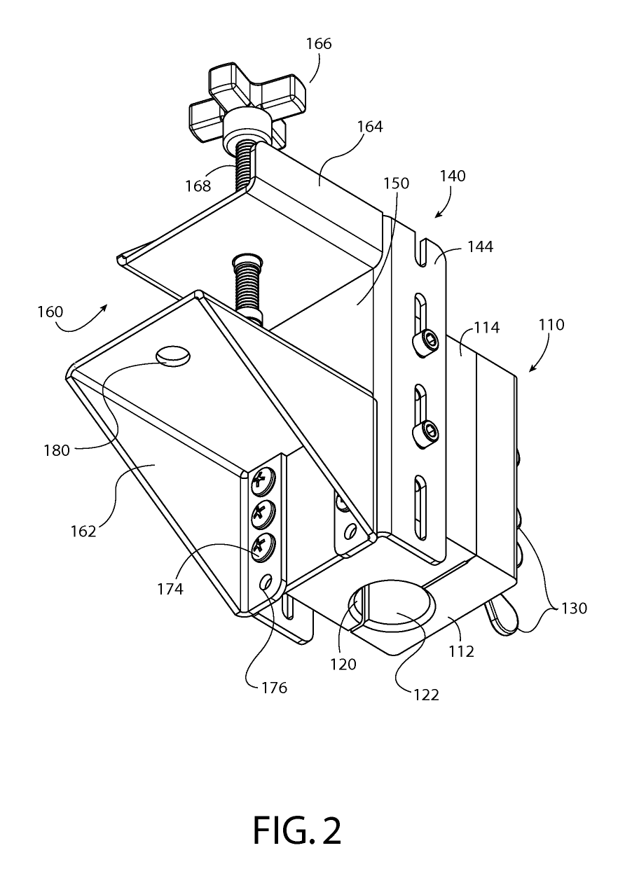

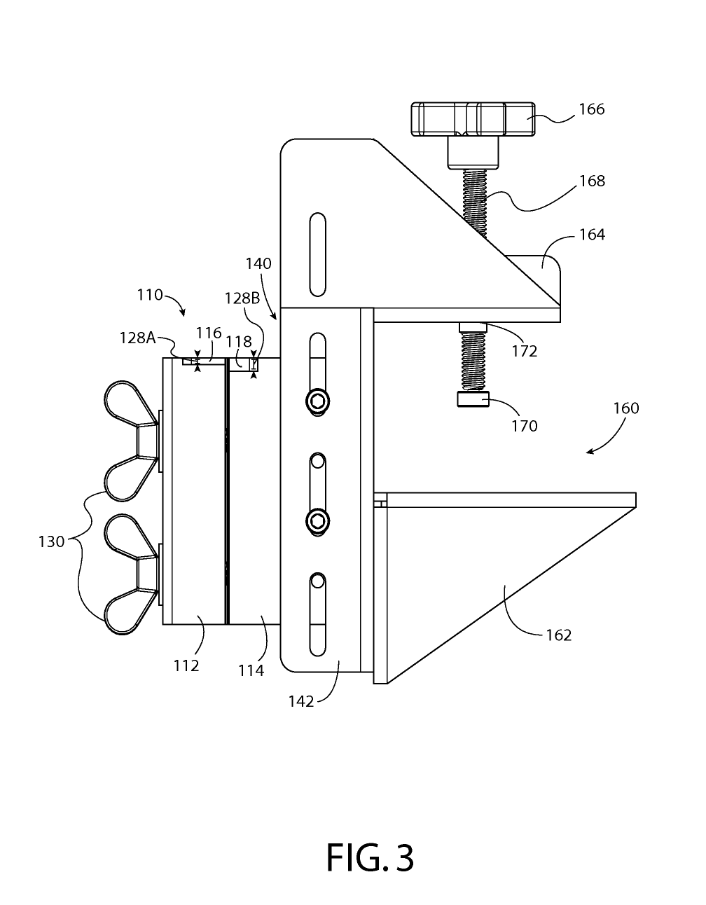

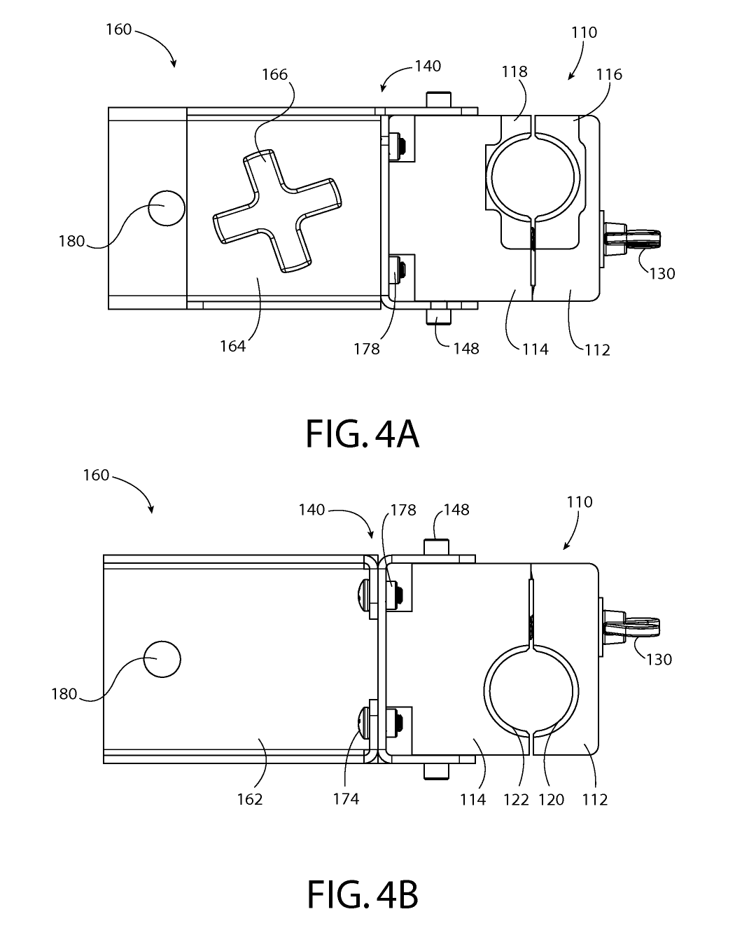

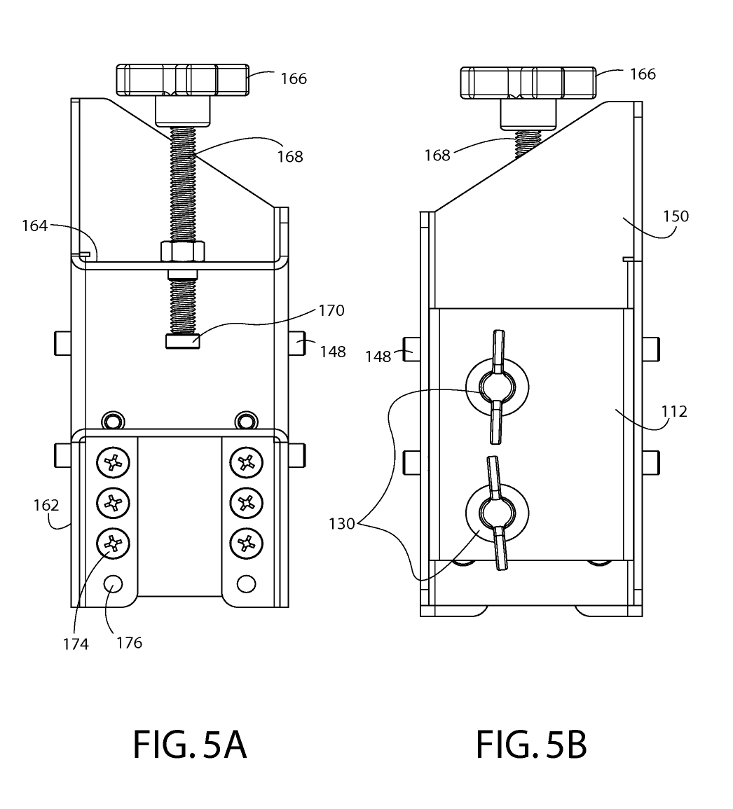

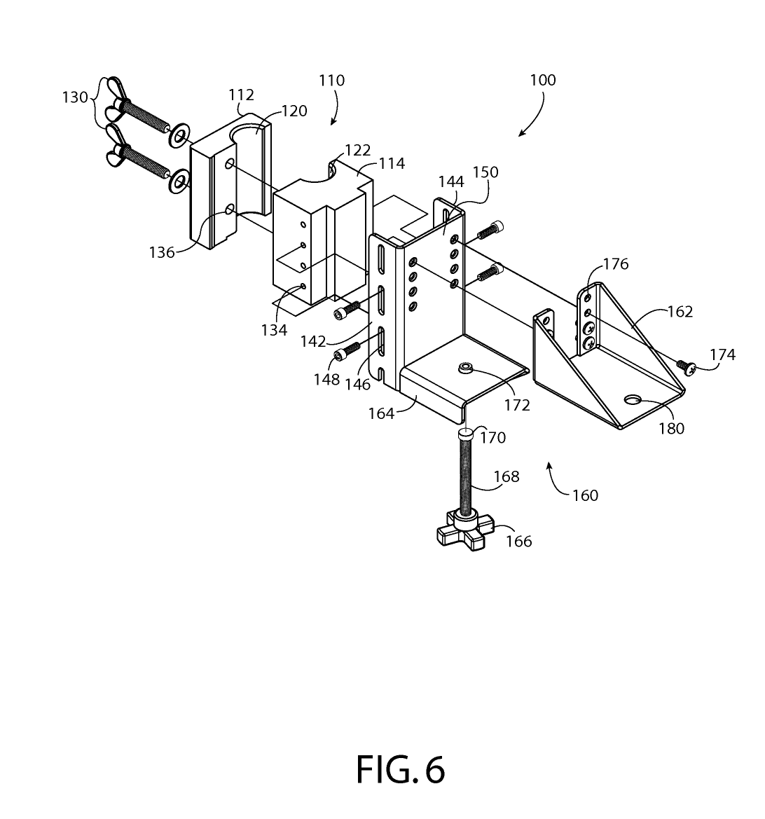

Turning now to the figures, FIGS. 1-6 illustrate various views of a keyed welding clamp assembly 100 disclosed herein. Keyed welding clamp assembly 100 includes orbital welder clamp 110, clamp adapter 140, and clamp mount 160.

Orbital welder clamp 110 includes first clamp portion 112 and second clamp portion 114. Second clamp portion 114 is fixed in relation to clamp adapter 140 and clamp mount 160, and first clamp portion 112 is moved toward or away from second clamp portion 114 to open or close orbital welder clamp 110. While first clamp portion 112 and second clamp portion 114 are generally shown to be of prismatic shape, and can specifically be of rectangular cross-section in two or more dimensions, it is understood that various shapes of greater or lesser complexity, and shapes having round portions, can be substituted or added in a complementary fashion without departing from the scope or spirit of the innovation.

First clamp portion 112 and second clamp portion 114 respectively include first key recess 116 located on first key face 124 and second key recess 118 located on second key face 126. First key face 124 and second key face 126 are located on corresponding surfaces of first clamp portion 112 and second clamp portion 114, and substantially exist in a plane describing a side of orbital welder clamp 110 closest to the orbital welder. One or both of first key recess 116 and second key recess 118 can have a key depth 128. In some embodiments, the depth can be substantially constant throughout one or both of first key recess 116 and second key recess 118, and a key associated with the orbital welder can be of substantially constant thickness or have a flat profile. In alternative embodiments, there can be more than one key depth (e.g., first key depth 128A and second key depth 128B) to mate with a key associated with the orbital welder having a variable depth profile. In still further embodiments, there can be more than one key depth to facilitate easy engagement or disengagement of a key of substantially constant thickness. Such configurations related to the depth or profile of first key recess 116 and second key recess 118, as well as the thickness or profile of keys aligning therewith, will be appreciated by those of ordinary skill in the art on study of the disclosures herein.

When orbital welder clamp 110 is closed, first key recess 116 and second key recess 118 define a shape fitting a key associated with the orbital welder. The shape may include a lip around all or a portion of one or both of first key recess 116 and second key recess 118 to securedly engage the key of the orbital welder. The key, which mates with both first key recess 116 and second key recess 118 in a closed position, is configured such that the orbital welder is fixed and remains in a known position.

First key recess 116 and second key recess 118 can define one or more shapes. In the illustrated embodiment, the cross-section shown is that of two rectangular recesses overlapping substantially centered with respect to one another at similar depth. First key recess 116 and second key recess 118 are shown disposed toward one corner of orbital welder clamp 110 distal from clamp mount 160. Further, first key recess 116 and second key recess 118 are illustrated as enclosed respectively by first clamp portion 112 and second clamp portion 114 at one end, while open at the other end.

While one possible embodiment of first key recess 116 and second key recess 118 is shown for purposes of explanation, it is understood that various alternatives can be employed without departing from the scope or spirit of the innovation. For example, various key configurations of greater or lesser complexity can be employed in alternative embodiments of the innovation. A key portion of a clamped orbital welder can include different arrangements including various bits, wards, cutouts, extensions, shanks, collars, pins, grooves, et cetera, which mate with one or both of first key recess 116 and second key recess 118. In some embodiments, first key recess 116 and second key recess 118 are asymmetrical, and may include different depths, angles, or cross-sectional shapes to ensure precise arrangement of the orbital welder.

In addition, first clamp portion 112 includes first extension recess 120, and second clamp portion 114 includes second extension recess 122. In the illustrated embodiments, first extension recess 120 and second extension recess 122 form a cylindrical void when orbital welder clamp 110 is closed. First extension recess 120 and second extension recess 122 are configured to retain an extension or extremity of an orbital welder, such as a cylindrical extension combining a manual welding handle and a welder motor. In the illustrated embodiment, first extension recess 120 is coincident with at least a portion of first key recess 116, and second extension recess 122 is coincident with second key recess 118. However, such overlapping design is not necessary under the scope and spirit of the innovation.

In the illustrated embodiment, first extension recess 120 and second extension recess 122 extend the full length of orbital welder clamp 110. In this fashion, the length of an extension from an orbital welder need not be bounded so long as its cross-sectional dimensions are substantially equal to or greater than those of first extension recess 120 and second extension recess 122 (e.g., such that orbital welder clamp 110 can securedly clamp the orbital welder extension). In configurations such as those illustrated, an electrical cable (or another line for supply or consumables) can be attached to the welder extension. In alternative embodiments, one or both of first extension recess 120 and second extension recess 122 can extend only part-way through first clamp portion 112 and/or second clamp portion 114, providing a closed or partially-closed bottom around the welder extension. In either configuration, cables or consumables can be routed through other avenues about the clamped orbital welder alternatively or in combination with attachment to an orbital welder extension.

Alignment of an orbital welder in orbital welder clamp 110 can ensure a flush fit having a known, consistent alignment with the table or other structure to which keyed welding clamp assembly 100 is mounted. Closing of orbital welder clamp 110 facilitates this alignment as small misalignments are reconciled by closing of first key recess 116 and second key recess 118, and first extension recess 120 and second extension recess 122, which require the welder key and welder extension to come into alignment to complete securing.

Opening, closing, or otherwise securing orbital welder clamp 110 is effected, at least in part, by clamp mechanism 130. Clamp mechanism 130 can be one or more means for moving or securing first clamp portion 112 with respect to second clamp portion 114. As illustrated, clamp mechanism 130 includes two threaded shaft having wing nut heads that can be turned to open or close orbital welder clamp 110 by moving first clamp portion 112 toward or away from second clamp portion 114. In the embodiment shown, the threaded shafts of clamp mechanism 130 screw in or out of clamp aperture 136 which passes through first clamp portion 112. Clamp aperture 136 passes at least partially into second clamp portion 114, and in particular embodiments can pass entirely through second clamp portion 114. In alternative embodiments other than those pictured, clamp aperture 136 only extends through first clamp portion 112, and does not extend into second clamp portion 114, and first clamp portion 112 is coupled to second clamp portion 114 by alternative means.

Clamp mechanism 130 can include opening or closing means other than the screw-drive means displayed. For example, various clasps, hasps, hinges, snaps, or other techniques known for opening, closing, tightening, or securing clamps, vises, or other closures can be employed without departing from the scope or spirit of the innovation. Further, while one technique is illustrated for purposes of understanding combined or hybrid techniques can be employed (e.g., hinge with threaded configuration, shafts in clamp mechanism 130 only partially threaded) without departing from the scope or spirit of the innovation. Additionally, other hardware such as washers 132 can be utilized to facilitate ease of use, wear resistance, or other purposes.

Orbital welder clamp 110 is fixed relative to a table or structure using clamp mount 160. Clamp adapter 140 is used to operatively couple orbital welder clamp 110 and clamp mount 160. Clamp adapter 140 can be a formed metal portion having a width configured to accommodate a dimension of at least second clamp portion 114 such that first flange 142 and second flange 144 overlap at least a portion of second clamp portion 114. Adapter slots 146 of first flange 142 and second flange 144 align with clamp attachment points 134 of second clamp portion 114 such that clamp fasteners 148 securely attach second clamp portion 114 to clamp adapter 140. Adapter slots 146 include space for lengthwise movement of fasteners 148 to allow height adjustment and/or flexible incorporation of second clamp portion 114. For example, without moving clamp mount 160, a clamp height of orbital welder clamp 110 can be adjusted using adapter slots 146 and clamp fasteners 148.

Interface plate 150 provides connectivity between clamp adapter 140 and clamp mount 160. In the illustrated embodiment, interface plate 150 is substantially orthogonal to first flange 142 and second flange 144, but alternative embodiments can be realized (particularly in embodiments where second clamp portion is not constructed exclusively of right angles) where other configurations are employed. Interface plate 150 can be formed with first flange 142 and second flange 144 through single-piece construction (e.g., formed through punching and bending of a blank), or constructed of multiple pieces through welding or the use of fasteners (e.g., bolts, adhesives).

Clamp mount 160 provides one or more structure attachment mechanisms. In the illustrated embodiment, clamp mount 160 includes at least static face 162 and closing face 164. In the illustrated embodiment, closing face 164 is permanently coupled to clamp adapter 140, and shares a common wall with interface plate 150. Closing face 164 can be coupled to interface plate 150 and/or clamp adapter 140 through single-piece construction (e.g., punched and bent from same blank of interface plate 150) or multi-piece construction (e.g., by fastening an L- or U-shaped channel or bracket to interface plate 150, welding).

Closing face 164 is operatively coupled to closure mechanism 168 using closure aperture 172. Closure aperture 172 can include a fixed or removable aperture through which closure mechanism 168 extends to increase or decrease space between closure contact 170 and static face 162. In the illustrated embodiment, closure mechanism 168 is a threaded shaft passing through matching threaded closure aperture 172. Turning mount interface 166 moves closure contact 170 toward or away from static face 162 of clamp mount 160, and can serve to clamp a table or other structure between static face 162 and closure contact 170. As with other aspects herein, alternative means of closing or clamping (e.g., one or more hinges, hasps, snaps, clasps, clips, torsion springs, tension springs, compression springs, clock springs) can be employed in clamp mount 160 to effect an open-able mechanism for securing clamp mount 160 to a table or structure without departing from the scope or spirit of the innovation.

Static face 162 attaches to interface plate 150 using fasteners 174 passing through mount attachment points 176. In alternative embodiments, static face 162 can be coupled to interface plate 150 through single-piece construction, or connection means other than those pictured (e.g., other fasteners, welding). Static face 162 rests against a surface of a table or structure to which keyed welding clamp assembly 100 is mounted.

Static face 162 is maintained against the table or structure by one or more securing mechanisms. As detailed above, closure mechanism 168 can be used to movably dispose closure contact 170 against the structure or table, allowing clamp mount 160 to be closed with static face 162 tightly pressed against one side of the table or structure, and closure contact 170 securing clamp mount 160 by tightly pressing against another side of the table or structure.

Static face 162 can also include mounting aperture 180. Mounting aperture 180 can be employed alternative to or in combination with closure mechanism 168 to securely fix clamp mount 160 to the table or structure. A screw, bolt, or other fastener can pass through mounting aperture 180 to secure at least static face 162 to the table or structure.

In still further alternative or complementary embodiments, various additional adhesives or fasteners can be employed alone or in combination with closure mechanism 168 and/or mounting aperture 180 to ensure clamp mount 160 is firmly attached to the table or structure. Further, one or more of static face 162, closing face 164, interface plate 150, and/or closure contact 170 can include friction-increasing coatings or materials, or can include non-planar surfaces matched to stably mate with surfaces of the table or structure. Similarly, while static face 162 and closing face 164 are shown constructed of portions oriented at right angles, embodiments can be realized under the disclosures herein where one or more sides of clamp mount 160 are askew or configured for mounting on structures not entirely composed of flat surfaces.

While illustrated embodiments of keyed welding clamp assembly 100 are shown in particular relative configurations (e.g., first key recess 116 and second key recess 118 oriented toward closing face 164) it is understood that alternative configurations are possible. For example, orbital welder clamp 110 can be flipped relative to clamp mount 160, or clamp adapter 140 can be oriented at another angle (e.g., 90-degrees clockwise with respect to the illustrated embodiment, 45-degrees counter-clockwise with respect to the illustrated embodiment) without departing from the scope or spirit of the innovation.

The shapes and sizes shown in keyed welding clamp assembly 100 can be modified for various purposes without departing from the scope or spirit of the innovation. For example, surfaces of keyed welding clamp assembly 100 can be rounded, beveled, angled, or sharpened to more closely match contacting portions, or ensure ease of fitting and removal. Further, various extensions or cutaways can be employed to modify characteristics such as resistance between moving parts, strength of construction, weight of assembly, and so forth. For example, second clamp portion 114 is illustrated with an extension having less surface area than the widest cross section of second clamp portion 114 in contact with interface plate 150. This extension can, for example, reduce friction when adjusting the height of orbital welder clamp 110 with reference to clamp adapter 140, and/or simplify fitting and engagement of second clamp portion 114 in clamp adapter 140. Finally, various flanges, walls, supports, or other parts (e.g., angled flanges of static face 162, angled wall shared between interface plate 150 and closing face 164) can be utilized for functional (e.g., strength) or aesthetic purposes without departing from the scope or spirit of the innovation.

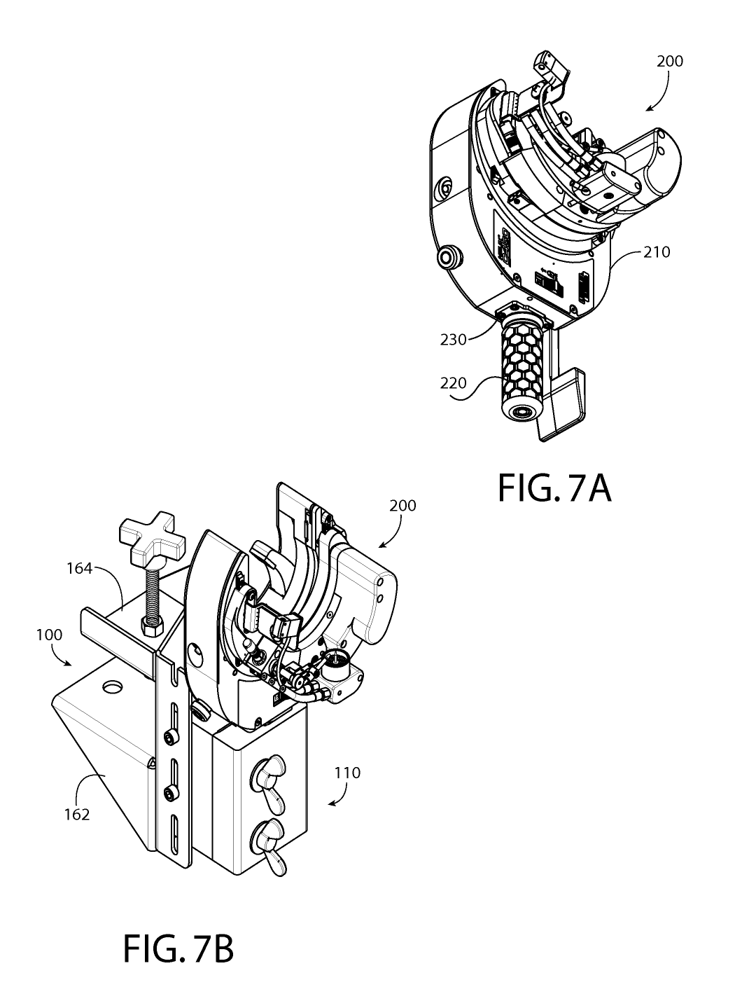

Turning now to FIGS. 7A and 7B, an orbital welder 200 is illustrated independently (FIG. 7A) and secured into keyed welding clamp assembly 100 (FIG. 7B). Orbital welder 200 includes welder body 210, with welder extension 220 extending from a side of welder body 210. In specific embodiments, welder extension 220 is a multi-function extension, and can serve as one or more of a handle for manual operation and maneuvering, a motor mount which contains a motor of orbital welder 200, and/or a connection point for electricity or various welding consumables.

Orbital welder 200 includes alignment key 230 which also serves as a face plate retaining welder extension 220. Alignment key 230 is matched to align with and precisely match first key recess 116 and second key recess 118 when welder clamp 110 is closed around welder extension 220.

As shown in FIG. 7B, keyed welding clamp assembly 100 can be attached to a table or other structure disposed between static face 162 and closing face 164, and orbital welder 200 is accurately and precisely aligned to facilitate transitioning of a work piece through orbital welder 200 during a welding operation.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to specific welding or metallurgy practices not expressly discussed (such as arc welding, laser welding, brazing, soldering, plasma cutting, waterjet cutting, laser cutting, and any other systems or methods using similar control methodology) without departing from the spirit of scope of the above discussed inventions. The embodiments and discussions herein can be readily incorporated into any of these systems and methodologies by those of skill in the art.

What is claimed is:

1. A clamp for an orbital welder, comprising:
an orbital welder clamp having a first clamp portion and a second clamp portion, the first clamp portion of the orbital welder clamp having a first key recess and a first extension recess, the second clamp portion of the orbital welder clamping having a second key recess and a second extension recess, the second key recess and the first key recess mating with an alignment key of the orbital welder where the first clamp portion is around an orbital welder extension in a closed position with respect to the second clamp portion;
a clamp adapter having at least two flanges and an interface plate, the at least two flanges couple with the second clamp portion, the interface plate of the clamp adapter configured to operatively couple the orbital welder clamp and a clamp mount; and
at least one structure attachment mechanism of the clamp mount that attaches to an external structure.

2. The clamp for an orbital welder of claim 1, wherein the structure attachment mechanism includes at least a closure mechanism that pinches the external structure between a closure contact and a static face of the clamp mount.

3. The clamp for an orbital welder of claim 1, wherein the structure attachment mechanism includes at least a mounting aperture through a static face of the clamp mount.

4. The clamp for an orbital welder of claim 1, wherein the first key recess extends into a first key face of the first clamp portion, and wherein the second key recess extends into a second key face of the second clamp portion.

5. The clamp for an orbital welder of claim 4, wherein the first key recess extends into the first key face to a first key depth, and wherein the second key recess extends into the second key face to a second key depth.

6. The clamp for an orbital welder of claim 1, wherein the first key recess and the second key recess have a substantially constant key depth, and wherein the alignment key is substantially flat.

7. The clamp for an orbital welder of claim 1, wherein the first key recess and the second key recess are substantially centered on at least one axis of the first clamp portion and the second clamp portion.

8. The clamp for an orbital welder of claim 1, wherein the first key recess and the second key recess are substantially symmetrical.

9. A method of fixing an orbital welder, comprising:
disposing a welder extension in a first extension recess of a first clamp portion and a second extension recess of a second clamp portion;
aligning an alignment key with a first key recess of the first clamp portion and a second key recess of the second clamp portion; and
closing the first clamp portion toward the second clamp portion using a clamp mechanism.

10. The method of claim 9, further comprising:
orienting a clamp mount about an external structure; and
securing a structure attachment mechanism of the clamp mount about the external structure.

11. The method of claim 10, wherein securing the structure attachment mechanism includes securing a fastener through a mounting aperture.

12. The method of claim 10, wherein securing the structure attachment mechanism includes closing a closure mechanism against at least one side of the external structure.

13. The method of claim 9, wherein the alignment key is substantially symmetrical.

14. The method of claim 9, wherein the alignment key is of constant thickness.

15. The method of claim 9, wherein the first extension recess is centered about the first key recess, and wherein the second extension recess is centered about the second key recess.

16. The method of claim 9, further comprising adjusting a clamp height of at least the second clamp portion by moving the second clamp portion about one or more adapter slots.

17. A welder system, comprising:
an orbital welder having a main body assembly supported adjacent to a workpiece;
an extension of the orbital welder;
an alignment key of the orbital welder;
a keyed welding clamp assembly for retaining the orbital welder having an orbital welder clamp, a clamp adapter, and a clamp mount;
a first clamp portion of the orbital welder clamp having a first key recess and a first extension recess;
a second clamp portion of the orbital welder clamping having a second key recess and a second extension recess, the second key recess and the first key recess mating with the alignment key of the orbital welder where the first clamp portion is around the extension in a closed position with respect to the second clamp portion;
at least one flange of the clamp adapter that couples with the second clamp portion;
an interface plate of the clamp adapter configured to operatively couple the orbital welder clamp and the clamp mount;
a closure mechanism of the clamp mount that pinches an external structure between a closure contact and a static face of the clamp mount; and
a mounting aperture through the static face of the clamp mount.

18. The welder system of claim 17, further comprising one or more adapter slots configured to position at least the second clamp portion with respect to the at least one flange of the clamp adapter.

19. The welder of claim 17, wherein the first extension recess is centered on the first key recess, and the second extension recess is centered on the second key recess.

20. The welder of claim 17, wherein the first key recess and the second key recess are symmetrical, and wherein the first extension recess and the second extension recess are symmetrical.
